(19) United States
(12) Patent Application Publication
(10) Pub. No.: US 2017/0316499 A1
(43) Pub. Date: Nov. 2, 2017

(54) PROCESSING CURRENCY DATA BETWEEN AN IN-MEMORY DATABASE AND A DISPLAY

(71) Applicant: SAP SE, Walldorf (DE)

(72) Inventors: Steffen Vollmert, Frankfurt (DE); Oliver Becker, Hofheim (DE); Achim Bolte, Hochheim (DE); Steven Coombs, Wiesloch (DE); Patricia David, Mannheim (DE); Guenter Graf, Reilingen (DE); Hartmut Koerner, Ladenburg (DE); Thomas Pohl, Leimen - St. Ilgen (DE); Ralf Reinke, Rauenberg (DE); Christian Seemann, Bruchsal (DE)

(21) Appl. No.: 15/139,871

(22) Filed: Apr. 27, 2016

(51) Int. Cl. G06Q 40/04; G06F 3/0484; G06Q 40/06; G06F 3/0481

(52) U.S. Cl. CPC G06Q 40/04; G06Q 40/06; G06F 3/0481; G06F 3/04842; G06F 3/04847

(57) ABSTRACT

The present disclosure provides methods, devices, systems, and computer program products for simulating currency risk by analyzing and manipulating financial data stored in an in-memory database and presenting results to a user on a display. The currency risk may be simulated by manipulating the stored financial data according to a business change, a foreign currency share change, and/or a foreign currency exchange rate change. Also provided is a scenario constructor that allows for the creation, simulation, and storage of complex currency risk scenarios.

### FIELD OF THE INVENTION

This disclosure relates to a system and method for processing currency data between an in-memory database and a display.

### BACKGROUND

The number of companies doing local-only business is decreasing. Now, the internet has enabled even small- and medium-sized companies with low numbers of employees to do global business, buying and selling things in countries across the world. As a result, an increasing number of sale and purchase transactions are occurring in foreign currency other than the base currency of the company.

By conducting business in a number of different currencies, companies can become exposed to currency risk, also known as foreign exchange risk. One example of currency risk occurs when there is a change in the exchange rate of the two currencies involved in a transaction between the date the transaction is initiated and the date the transaction is settled. For instance, a customer in South Africa may use an online web-shop to purchase a DVD player from a supplier in Japan for the price of R1999 South African Rand (ZAR). On the date of purchase, this may be equivalent to ¥15526.46 Japanese Yen (JPY). However, during the time between the customer's purchase and the payment has settled at the supplier's bank, the ZAR may have weakened against the JPY such that R 1999 is now equivalent to only ¥15500, for an exchange rate loss of ¥26.54.

Companies may protect against currency risk through financial hedging. However, to correctly hedge, it is important to fully model and understand the scope of future currency risk, including, for example, increased or decreased sales in particular locales, changing exchanging rates over time, and how those changes will impact the financials of a company.

### SUMMARY

Embodiments of the present disclosure provide systems and methods for simulating currency risk by analyzing and manipulating financial data. Embodiments of the present disclosure also provide for currency risk simulation using financial data stored in an in-memory database, to take advantage of the greater processing power and speed than is typically available in traditional databases. For example, in-memory databases may deliver increased data access speed compared to relational databases stored outside of main memory, and consequently may provide faster program execution. Real-time program execution may also be implemented due to the increased speed of program execution. These speed and performance increases allow currency risk to be simulated through the analysis and manipulation of data at a very fine, granular level, such as at the level of individual business line items. In doing so, embodiments of the present disclosure allow financial analysts to quickly and accurately assess present and future currency risk according to the user company's specific financial situation and projections.

Also provided is a scenario constructor that allows for the creation, simulation, and storage of complex scenarios involving business changes that may impact currency risk, including, for example, revenue and/or cost adjustments, foreign currency share changes, and foreign currency exchange rate changes.

Embodiments of the present disclosure will be described in detail in the exemplary embodiments presented in the drawings and disclosure set forth below.

### BRIEF DESCRIPTION OF THE DRAWINGS

FIG. 1 shows a flow chart by which the currency risk simulator proceeds according to an example embodiment.

FIG. 2 shows a simplified central menu for a currency risk simulator according to an example embodiment.

FIG. 3 shows a simplified foreign currency share analysis according to an example embodiment.

FIG. 4 shows a simplified interface of the currency risk simulator during the adjustment of business changes and currency share according to an example embodiment.

FIG. 5 shows a simplified interface of the foreign currency band width analysis according to an example embodiment.

FIG. 6 shows a simplified interface of the currency risk simulator during the adjustment of currency rate according to an example embodiment.

FIG. 7 shows a simplified interface of the currency risk simulator showing the impact results according to business changes, currency share adjustments, and currency exchange rates changes according to an example embodiment.

FIG. 8 shows a simplified interface of the scenario constructor according to an example embodiment.

FIG. 9 shows a block diagram showing an in-memory implementation of a database environment supporting the currency risk simulator according to an exemplary embodiment.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Exemplary embodiments of the present disclosure provide for a method, device, system, and computer program product for simulating currency risk.

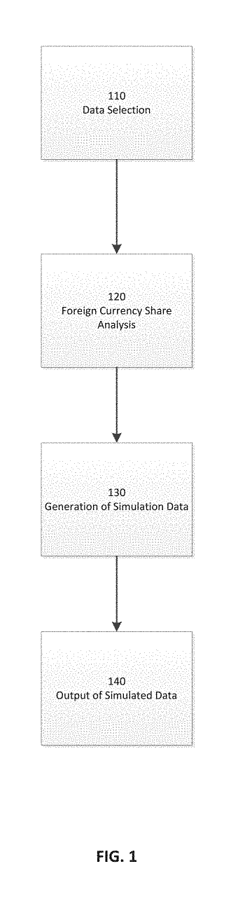

FIG. 1 shows a flow diagram 100 by which the currency risk simulator proceeds according to an example embodiment. In one embodiment, the steps of the currency risk simulator include data selection 110, foreign currency share analysis 120, generation of simulated data 130, and output of simulated data 140.

Prior to using the currency risk simulator, or at any time during use, the user may set personal preferences for the currency risk simulator. These preferences may include such things as default values and formatting (e.g., mm/dd/yyyy vs. dd/mm/yyyy; $xxx,xxx.yy vs. $xxx.xxx,yy, etc.). Other personal preferences may include, for example, Set/Get parameters and/or relevant file locations for retrieving or storing data. Additionally, the user may define the necessary currency exchange rates. In some embodiments, exchange rates are obtained from a database. In a particular embodiment, the exchange rates are imported to the currency risk simulator from the SAP® ERP-Treasury System. Both historical and current exchange rates may be imported. In other embodiments, the user may manually define an exchange rate for any set of currencies for a particular time period. That is, the user may enter that the currency risk simulator should use, for example, an exchange rate of 1 USD/0.923 EUR for financial transactions occurring between Dec. 1, 2015 and Dec. 31, 2015.

During data selection 110, the user selects the set of financial data on which currency risk simulation is desired. The user may select financial data along typical axes, for example, according to a certain time frame, or according to certain geographic regions. The user may also select financial data according to typical reporting structures, for example, an income statement, a balance sheet, or cash flow. If user may also select data at a more granular level as allowed by the stored financial data. In some embodiments, the user may select a set of general ledger line items from a general ledger accounting database for currency risk simulation.

In some embodiments, the financial data is stored in a database, preferably an in-memory database. It is to be understood by one of skill in the art that any relevant financial data stored in the course of a user's business may be selected for currency risk simulation. For example, the user may select actual or plan data from any organization unit, for any time frame, or according to any reporting structure or account group, limited only by the stored financial data. In one embodiment, the financial data is stored in the SAP® HANA in-memory database. SAP® HANA is a widely popular in-memory computing platform that may include S/4 HANA Finance, also known as Simple Finance, or sFin. sFin includes a central database table ACDOCA, which is a universal table that collects data from SAP® G/L Accounting, Asset Accounting, Controlling, and Material Ledger databases. The ACDOCA table includes all dimensions of financial data at a line item level, such that a user may select these line items for use in the currency risk simulator. It is to be understood by one of ordinary skill that the currency risk simulator is not limited to a specific in-memory database system, and the above description is used only for exemplary purposes.

In some embodiments, the user may also select the time frame for which currency risk simulation is to be done. For example, the user may desire to simulate currency risk for, for example, the upcoming month, the upcoming fiscal quarter, or the upcoming fiscal year. The user may also indicate the desired output format of the currency risk simulation. In some embodiments, the output format is automatically selected to match the format of the selected financial data. That is, if, for example, the user has selected an income statement as the financial data for the currency risk simulation, the output of the currency risk simulator may be in the form of an income statement as well.

After the user has selected the data upon which to perform the currency risk simulation as well as the desired simulation time frame and output format, the currency risk simulator of the present disclosure conducts a foreign currency share analysis 120. During foreign currency share analysis 120, the currency risk simulator analyses the selected data to determine the relevant share of each foreign currency present in the selected financial data. The currency risk simulator may use exchange rate data as discussed above, such that the selected financial data occurring at a particular time in the past is assessed according to the foreign currency exchange rate occurring at that particular time according to either imported exchange rate data or exchange rates manually entered by the user. In some embodiments, the currency risk simulator will present the user with a list of the most relevant foreign currencies. For example, the currency risk simulator may determine the most relevant foreign currencies according to which foreign currencies present in the selected financial data have the highest aggregate value across all selected transactions, which foreign currencies are used the most frequently, or which accounts and business transactions are affected most by the foreign currency share.

Once presented with the results of the foreign currency share analysis 120, a user may filter or sort the foreign currency share analysis along any metric, including, for example, the nominal amount of transactions occurring in each foreign currency, the number of transactions occurring in each foreign currency, by transaction type, i.e., debits, credits, revenues, and/or costs, or by account group, i.e., raw materials, incoming, packaging, salaries, etc. After viewing, filtering, and/or analyzing the foreign currency share analysis, a user may select the particular foreign currencies for which further currency risk simulation is desired, including one, some, or all of the foreign currencies present in the selected financial data.

During the generation of simulated data 130, the user is presented with the selected reference data at the desired level of granularity along with detailed foreign currency share information obtained during the foreign currency share analysis step 120. In some embodiments, the selected financial data is presented to the user according to a selected reporting structure, for instance an income statement, balance sheet, or cash flow. In some embodiments, the currency risk simulator may present additional details such as the account balance per account for the selected financial data according to the selected timeframe. In other embodiments, the currency risk simulator may present additional details derived from the selected data, including, for example, net revenue, gross income, net income, etc. In some embodiments, each of the items above may be further broken down according to the detailed financial currency share according to the foreign currency share analysis step 120.

In order to generate the simulated financial data from the selected financial data, the user may input desired changes to simulate for a selected period of time. These may include general business changes, foreign currency share changes, and/or foreign currency exchange rate changes. A general business change would be used to generally increase or decrease the selected financial data. For example, the user may want to increase a revenue account by a certain percentage (e.g., 5%), while increasing a cost account by some other amount (e.g., 10%). In some embodiments, the increase or decrease may be applied to any item of the selected financial data on an individual or group level. A foreign currency share change would allow a user to change the mix of foreign currencies for the user's expected future business. For example, a user's business currently has business conducted in USD, EUR, JPY, GBP, and ZAR. The user may expect European business to grow, leading to a 20% increase in business conducted in EUR, while the South African branch of the business will close, leading to a 100% decrease (or 0% currency share) of business conducted in ZAR. A foreign currency exchange rate change allows a user to change the expected currency exchange rate between pairs of relevant foreign currencies. In some embodiments, the above changes may be made independently of one another.

In some embodiments, appropriate ranges of foreign currency exchange rate changes may be estimated according to a band width analysis. A band width analysis may allow the user to determine the impact that a range of foreign currency exchange rate changes may have on a particular item of financial data. In some embodiments, the user may specify the maximum change the user is willing to accept for a particular item of selected financial data, and the currency risk simulator will calculate the maximum change a foreign currency exchange rate may have to maintain the particular item of financial data within the desired range. In some embodiments, the band width analysis may utilize any entered business or foreign currency share changes in calculating the maximum foreign currency exchange rate change. In other embodiments, the band width analysis may calculate the maximum foreign currency exchange rate change independently of other entered changes. In some embodiments, the maximum foreign currency exchange rate change may be calculated for one, some, or all of the foreign currencies present in the selected data. In other embodiments, the maximum foreign currency exchange rate change of a particular currency may be calculated independently of the foreign currency exchange rate changes of any other currencies present in the selected data. In some embodiments, the maximum foreign currency exchange rate change of a particular currency may be dependent on the foreign currency change rate changes of one, some, or all of the other currencies present in the selected data.

The user may enter changes over multiple periods of times, such that simulated data may be generated for one, two, or more points of time in the future. This allows a user to generate simulated data according to the specific future projections of the user's business or exchange rate expectations, such as seasonally fluctuating sales in particular locales or steadily weakening/strengthening currencies.

After generating the simulated data by entering the desired business, foreign currency share, and/or foreign currency exchange rate changes, the currency risk simulator outputs the simulated data to a display device in a step 140. The output may provide a comparison of the selected financial data to the generated simulated data according to the desired business, foreign currency share, and/or foreign currency exchange rate changes. In some embodiments, the output of the simulated data may be presented according to the format of the selected financial data, such that corresponding changes may be easily viewed.

In some embodiments, the generation of the simulated data and output of the simulated data may occur synchronously. That is, the currency risk simulator may allow the user to the see the impact of changes upon entry of each change into the currency risk simulator, rather than according to a calculation done after all changes have been entered. In some embodiments, the currency risk simulator takes advantage of the characteristics of the in-memory database from which the selected financial data is obtained in order to synchronously generate the simulated data from the selected financial data according to an inputted change. For example, in-memory databases may deliver increased data access speed compared to relational databases stored outside of main memory, and consequently may provide faster program execution. Accordingly, real-time program execution allowing for the synchronous generation and output of simulated data may also be implemented due to the increased speed of program execution. This allows a user to input various adjustments, i.e., business changes, foreign currency share changes, and foreign currency exchange rate changes, and see the resulting impact immediately.

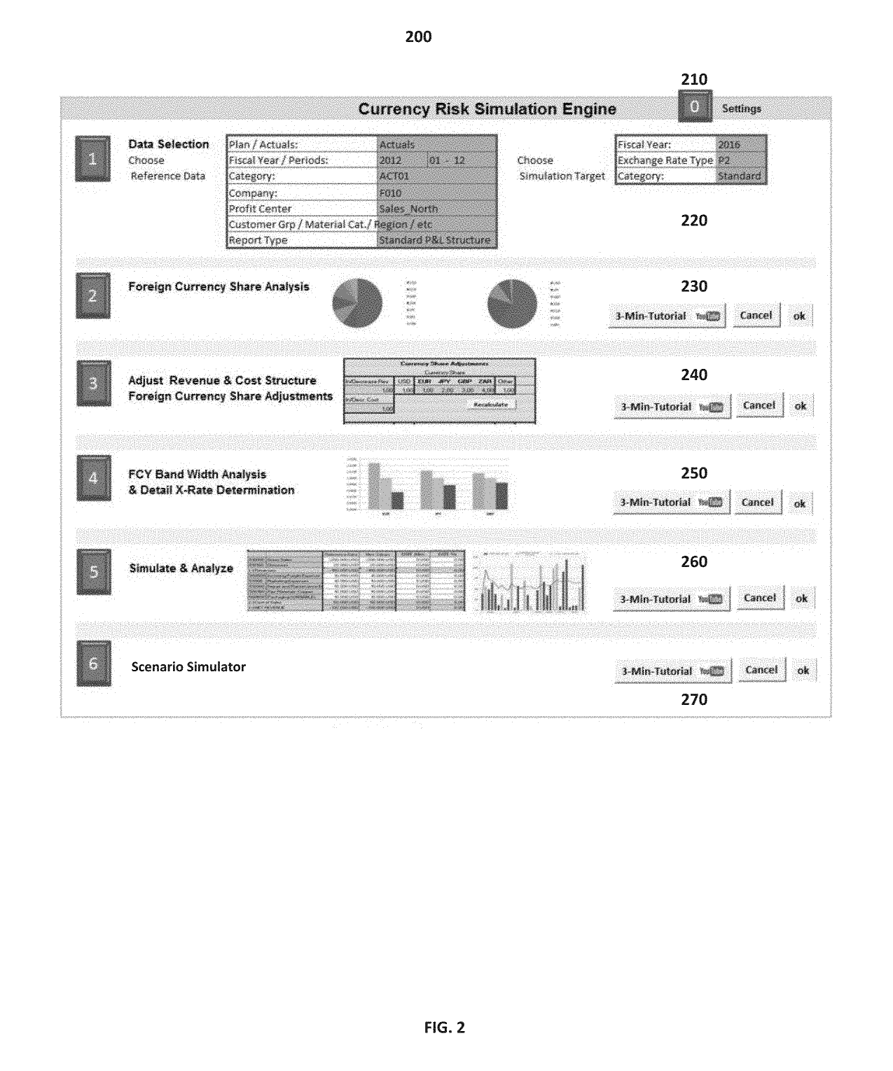

FIG. 2 shows a simplified central menu 200 for a currency risk simulator according to an example embodiment. In some embodiments, the central menu of the currency risk simulator allows the user to easily access any area of the currency risk simulator. For example, the personal preferences of the currency risk simulator, including, for example, default values, formatting, and others as discussed above, may be accessed by selecting “Settings” section 210. Other aspects of the currency risk simulator may be accessed by selecting the respective area, including, for example, “Data Selection” area 220 or “Foreign Currency Share Analysis” area 230. Upon selection of “Data Selection” area 220, the user may select the desired financial data upon which to conduct currency risk simulation, as well as the selected simulation time frame, as discussed in connection with step 110, above. In some embodiments, “Data Selection” area 220 may display information regarding the selected financial data or simulation time frame. For example, as shown in FIG. 2, the user has selected actual financial data from twelve months of fiscal year 2012 in the form of a standard P&L structure. As also can be seen in FIG. 2, the user will be simulating currency risk for fiscal year 2016.

Upon selection of “Foreign Currency Share Analysis” area 230, the user may conduct the foreign currency share analysis on selected financial data, as discussed in connection with step 120, above. As discussed in connection with step 130, above, the business and foreign currency share changes may be entered by the user upon selection of area 240, and foreign currency exchange rate changes may be entered by the user upon selection of area 250. The user may also conduct a band width analysis for a foreign currency or foreign currencies upon the selection of area 250. The user may view the simulated data output for further analysis, as discussed in connection with step 140, above, by selecting area 260.

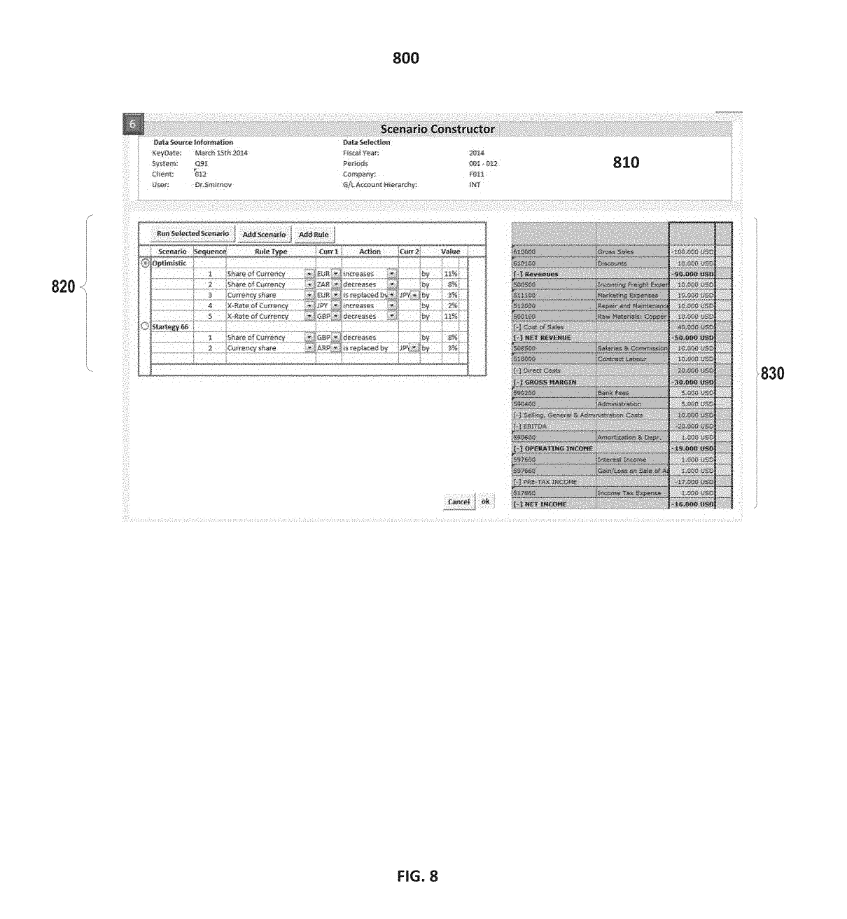

In some embodiments, the user may also select “Scenario Simulator” 270. The scenario simulator allows the user to construct various currency risk scenarios according to a set of user-defined rules. These scenarios include rules similar to those discussed above, such as, for example, revenue and/or cost adjustments, foreign currency share changes, and foreign currency exchange rate changes. The scenario simulator is discussed more fully in connection with FIG. 8, below.

In some embodiments, the central menu 200 may allow the user to view instructions, help guides, or tutorials regarding each of the respective areas of the currency risk simulator. For example, as shown in FIG. 2, areas 230, 240, 250, 260, and 270 each contain a link to a three-minute tutorial video to explain the respective section of the currency risk simulator.

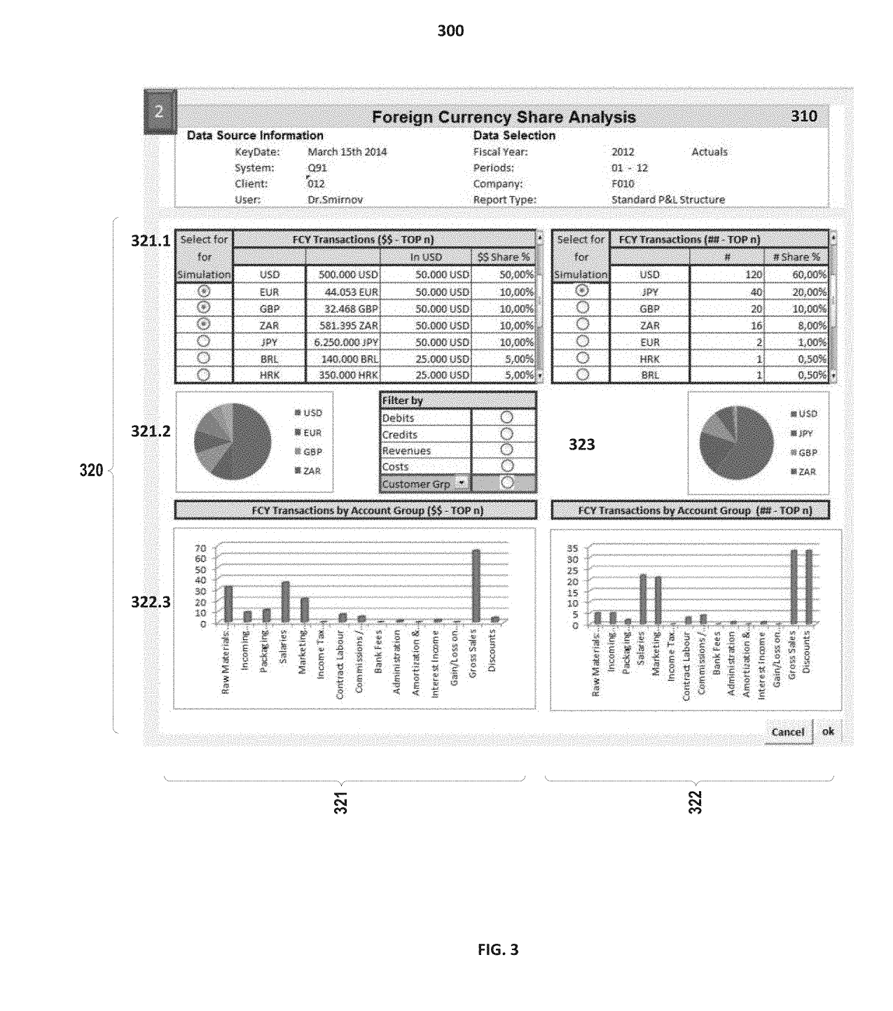

FIG. 3 shows a simplified foreign currency share analysis 300 according to an example embodiment. Here, as discussed in connection with step 120, above, the user is presented with the foreign currency share analysis of the selected financial data. In some embodiments, foreign currency share analysis 300 may comprise an overview area 310 and analysis area 320. In some embodiments, overview area 310 may include information about the user and the selected financial data, including, for example, the time period and/or reporting structure from which it is derived. For example, as shown in FIG. 3, the selected financial data upon which foreign currency share analysis has been undertaken is from twelve months of fiscal year 2012 in the form of a standard P&L structure.

Analysis area 320 displays the foreign currency share analysis for each foreign currency present in the selected financial data. The analysis area 320 may display a list of the most relevant foreign currencies according to, for example, which foreign currencies present in the selected financial data have the highest aggregate value across the selected financial data and which foreign currencies are used the most frequently across the selected financial data. For example, as shown in FIG. 3, analysis area 320 comprises an area 321 that displays foreign currency share information organized by nominal value and an area 322 that displays foreign currency share information organized by the number of transactions.

Each of areas 321 and 322 may further display relevant foreign currency share analysis according to different visualizations or metrics. For example, area 321.1 displays the list of foreign currencies present in the selected financial data according to the nominal value of each currency, ranked according to the percentage share of total nominal value. Area 321.1 may also comprises selection toggles that allow the user to select specific foreign currencies for further currency risk analysis. Foreign currency share analysis may also be displayed in a visual format, for example a pie chart, in area 321.2. Area 321.3 may display the nominal value of transactions by account group, i.e., raw materials, incoming, packaging, salaries, etc. Although not labeled, it is to be appreciated that area 322 may comprise analogous areas displaying foreign currency share analysis as organized according to the number of transactions occurring in each foreign currency.

In some embodiments, the user may filter the foreign currency share analysis data by interacting with area 323. In some embodiments, as shown in FIG. 3, the user may filter the foreign currency share analysis by transaction type, i.e., debits, credits, revenues, and/or costs, or by group.

After viewing the foreign currency share analysis and selecting the desired foreign currencies for currency risk simulation, the user may select the “OK” button to proceed to the next area of the currency risk simulator. The user may also select the “Cancel” button to return to the prior area of the currency risk simulator. In some embodiments, selection of the “OK” or “Cancel” buttons may return the user to the currency risk simulator central menu 200.

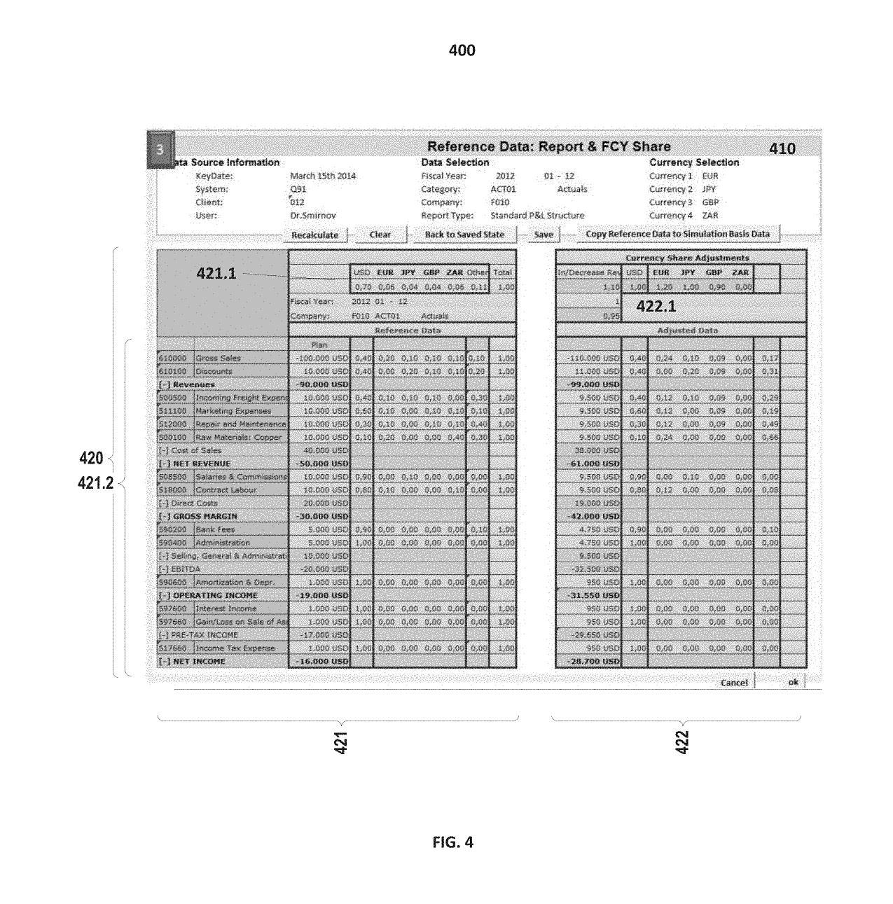

FIG. 4 shows a simplified interface 400 of the currency risk simulator during the adjustment of business changes and currency share changes according to an example embodiment. Here, as discussed in connection with step 130, above, the user may enter desired business and foreign currency share changes. In some embodiments, the interface 400 may comprise an overview area 410 and analysis area 420. In some embodiments, overview area 410 may include information about the user, the selected financial data, including, for example, the time period and/or reporting structure from which it is derived, and the foreign currencies the user has selected for further currency risk simulation. For example, as shown in FIG. 4, the user has selected EUR, JPY, GBP, and ZAR for currency risk simulation.

Analysis area 420 comprises a reference data area 421 and a simulated data area 422. Reference data area 421 displays the selected financial data along with the foreign currency share information for the selected currencies. Foreign currency share area 421.1 displays the relative percentages of each foreign currency for the entirety of the selected financial data. For example, in FIG. 4, USD accounts for 70% of the selected financial data, 6% is in EUR, 4% is in JPY, 4% is in GBP, 6% is in ZAR, and 11% is in other currencies (note that the percentages sum to greater than 100% due to rounding, e.g., EUR is 5.5% and JPY is 3.5%). Data display area 421.2 displays the selected financial data at a more granular level. In some embodiments, the selected financial data may be displayed according to the selected financial reporting structure. In other embodiments, the selected financial data may be displayed at a level of granularity as defined by the user. For each item of financial data displayed in data display area 421.2, the foreign currency share for that particular item is also displayed in the manner of foreign currency share area 421.1. For example, as shown in FIG. 4, the EUR accounts for 20% of Gross Sales.

Simulated data area 422 allows the user to input selected business and foreign currency share changes, i.e., the user's future projections for business revenues, costs, and foreign currency shares. These may be entered in adjustment input area 422.1. For example, in FIG. 4, with respect to business changes, the user has estimated future revenues as increasing by 10% (or 1.10 times the reference data) and costs decreasing by 5%. Simulated data incorporating these projections are generated from the selected financial data and displayed. For example, as shown in FIG. 4, the projected 10% increase in revenues is shown for the Gross Sales item by increasing the reference data amount of $100,000 USD of Gross Sales by 10% to $110,000.

The user may enter foreign currency share changes in a similar manner. For example, the user may project that amount of EUR transactions will increase by 20%, those in JPY will stay the same, those in GBP will decrease by 10%, and that there will be no transactions in ZAR for the simulated time frame. As above, simulated data incorporating these projections are generated and displayed. For example, as shown in FIG. 4, the projected 20% increase in EUR transactions increases the 20% EUR share of Gross Sales to 24%.

After inputting the desired business and foreign currency share changes, the user may select the “OK” button to proceed to the next area of the currency risk simulator. The user may also select the “Cancel” button to return to the prior area of the currency risk simulator. In some embodiments, selection of the “OK” or “Cancel” buttons may return the user to the currency risk simulator central menu 200.

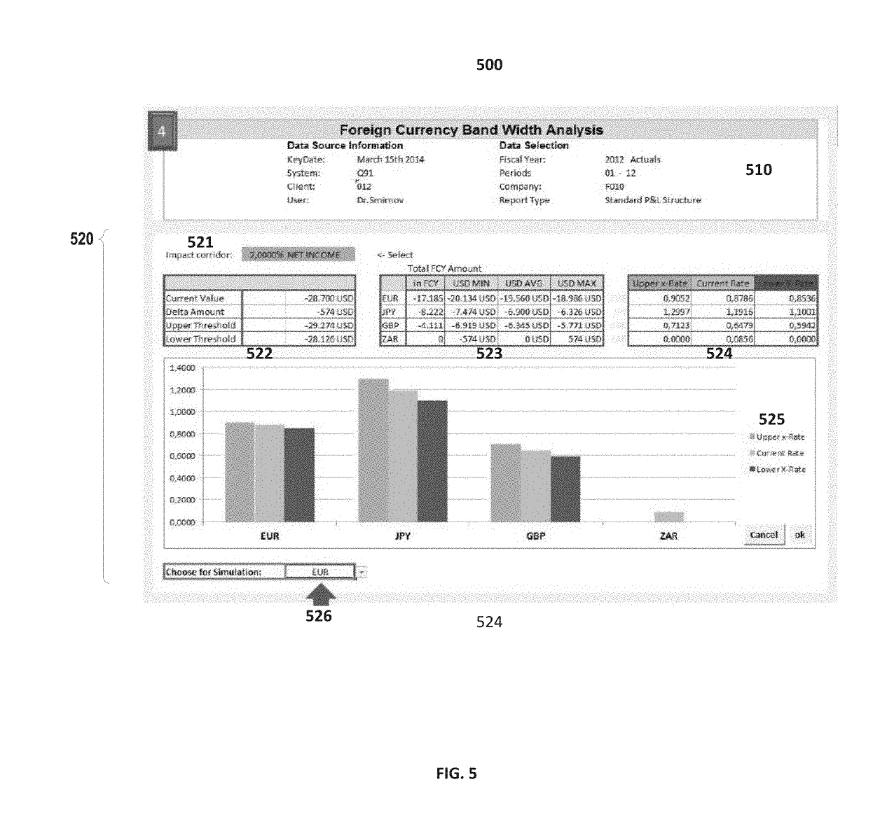

FIG. 5 shows a simplified interface 500 of the foreign currency band width analysis according to an example embodiment. Here, as discussed in connection with step 130, above, the user may conduct a band width analysis to determine how changing foreign currency exchange rates may affect the selected financial data. In some embodiments, the interface 500 may comprise an overview area 510 and analysis area 520. In some embodiments, overview area 510 may include information about the user and the selected financial data, including, for example, the time period and/or reporting structure from which it is derived.

Analysis area 520 may comprise a selection area 521 in which the user may enter the maximum allowable change as a result of foreign currency exchange rate changes. In some embodiments, maximum allowable change may be with respect to an individual item of the selected financial data, a portion of the selected financial data, or all of the selected financial data. In other embodiments, the maximum allowable change may be with respect to a reporting position in a financial structure. For example, as shown in FIG. 5, the user has entered a maximum allowable change of “Net Income” of 2%.

Upon entry of the maximum allowable change, the current reference value from the selected financial data is shown in reference data area 522. Reference data area 522 may also display the nominal amount equivalent to the maximum allowable change entered as a percentage in selection area 521. An upper and lower threshold of the selected financial data may also be displayed.

The currency risk simulator may then calculate and display the range of foreign currency exchange rates of the foreign currencies selected for currency risk simulation that is allowable given the maximum allowable change in the selected financial data. In some embodiments, the currency risk simulator calculates the impact of foreign currency exchange rate changes on the selected financial data according to the projected foreign currency share changes entered by the user. In other embodiments, the currency risk simulator calculates the impact of foreign currency exchange rate changes on the selected financial data according to the reference data's foreign currency share. The calculated exchange rate band widths may be displayed in areas 523, 524, and 525. In area 523, the nominal amounts of each foreign currency comprising the selected financial data are displayed. The equivalent amount in base currency is also displayed, together with the maximum and minimum amounts of equivalent base currency according to the current and calculated minimum and maximum foreign currency exchange rates. In area 524, the current, maximum, and minimum foreign currency exchange rate values for each foreign currency are displayed. These maximum and minimum calculations are the upper and lower foreign exchange rate limits that would maintain the selected financial data within the maximum allowable range entered in selection area 521. In area 525, the current, maximum, and minimum foreign currency exchange rates for each foreign currency are displayed in a visual format, for example a graph.

Using selector 526, the user may select a specific foreign currency for more granular currency risk analysis. In some embodiments, the user may select one, some, or all of the foreign currencies for further currency risk analysis.

After conducting the foreign currency band width analysis and selecting a foreign currency for further currency risk analysis, the user may select the “OK” button to proceed to the next area of the currency risk simulator. The user may also select the “Cancel” button to return to the prior area of the currency risk simulator. In some embodiments, selection of the “OK” or “Cancel” buttons may return the user to the currency risk simulator central menu 200.

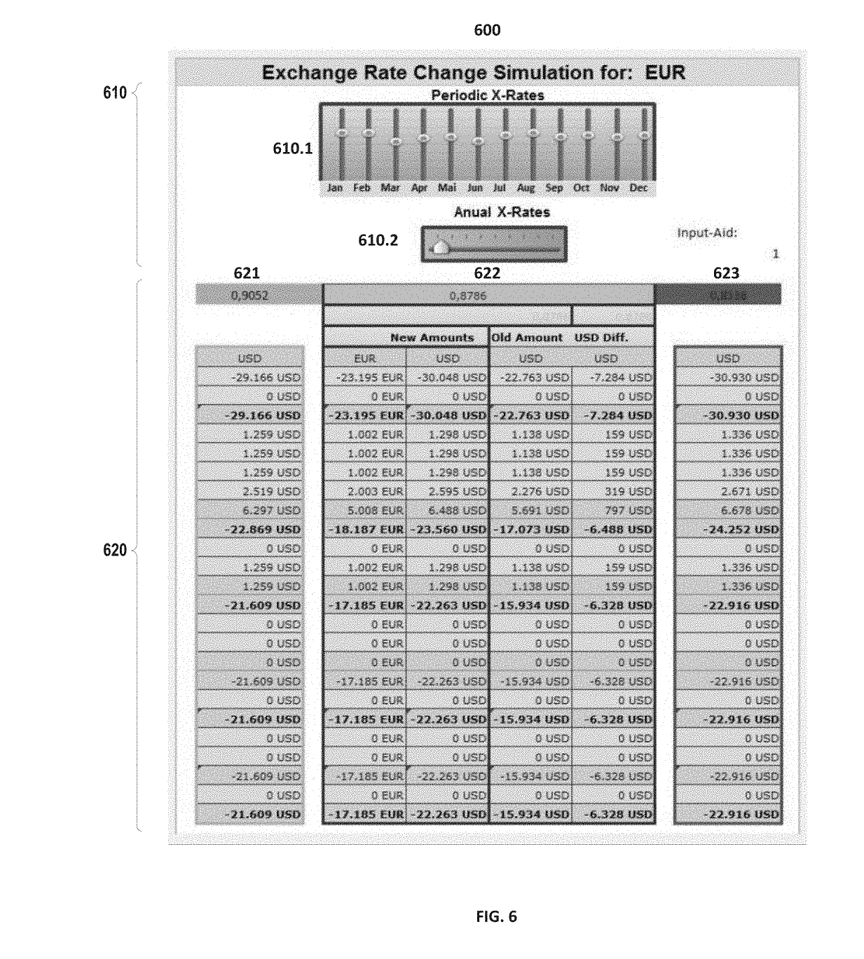

FIG. 6 shows a simplified interface 600 of the currency risk simulator during the adjustment of currency rate according to an example embodiment. Here, as discussed in connection with step 130, above, the user may adjust the foreign currency exchange rates for the currency risk simulation. In some embodiments, the interface 600 may comprise an adjustment area 610 and an analysis area 620. In adjustment area 610, the user may adjust the foreign currency exchange rate of the selected foreign currency as desired. The user may adjust the foreign currency exchange rate along various time frames as desired. For example, as shown in FIG. 6, the user may adjust the foreign currency exchange rate on a monthly basis (610.1), or adjust a single annual exchange rate to be used for the entire simulated time period (610.2).

Analysis area 620 may comprise minimum exchange rate area 621, maximum exchange rate area 623, and simulated exchange rate area 622. In some embodiments, the exchange rates displayed in maximum exchange rate area 623 and minimum exchange rate area 623 are determined according the band width analysis, as discussed in relation to FIG. 5. The impact of these maximum and minimum exchange rates on the selected financial data is displayed in the base currency, as shown in FIG. 6. In some embodiments, the maximum and minimum exchange rates as displayed in areas 621 and 623 limit the range in which the foreign currency exchange rate may be adjusted in adjustment area 610. In other embodiments, the maximum and minimum exchange rates may be entered manually, or eliminated to allow the user to simulate any desired foreign currency exchange rate.

As adjustments are made the foreign currency exchange rate in adjustment area 610, the exchange rate displayed in simulated exchange rate area 622 may change accordingly. The impact of the simulated exchange rate is displayed below. In some embodiments, the simulated financial data is displayed in both the foreign currency and equivalent base currency according to the simulated exchange rate. In some embodiments, the difference (in base currency) between the reference financial data and the simulated financial data is also displayed. After setting the simulated foreign currency exchange rate (or rates, for multiple time frames) for a specific foreign currency, the user may additionally set the simulated foreign currency exchange rate(s) for additional foreign currencies selected previously. After making the desired foreign currency exchange rate changes, the user may then view and analyze the resulting simulated data.

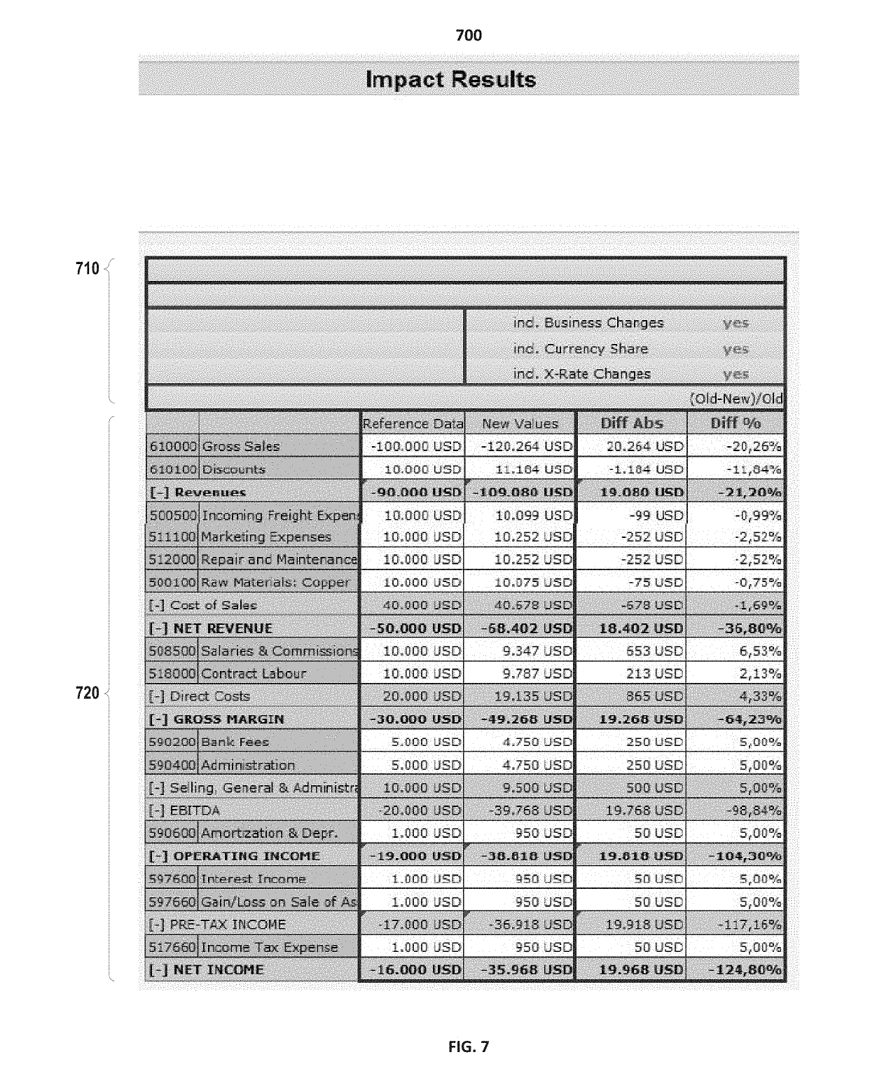

FIG. 7 shows a simplified interface 700 of the currency risk simulator showing the impact results according to business changes, currency share adjustments, and currency exchange rates changes according to an example embodiment. Here, as discussed in connection with step 140, above, the user may view the generated simulated financial data for review and analysis. Interface 700 may comprise an adjustment area 710 and an analysis area 720. In adjustment area 710, the user may select which of the desired business, foreign currency share, and foreign currency exchange rate changes are simulated. For example, as shown in FIG. 7, all of the entered business, foreign currency share, and foreign currency exchange rate changes are to be used for the currency risk simulation.

In analysis area 720, the reference data for each of the selected financial data is displayed alongside the simulated financial data incorporating each of the selected business, foreign currency share, and/or foreign currency exchange rate changes. In some embodiments, the nominal difference between the reference value and simulated value is also displayed. In other embodiments, the percentage difference between the reference data and the simulated data is also displayed.

The present disclosure also contemplates a scenario constructor where various scenarios may be constructed and simulated. These scenarios include rules similar to those discussed above, such as business changes, foreign currency share changes, and foreign currency exchange rate changes. FIG. 8 shows a simplified interface 800 of the scenario constructor according to an example embodiment. In some embodiments, the scenario constructor may comprise an overview area 810, scenario construction area 820, and reference data area 830. In some embodiments, overview area 810 may include information about the user and the selected financial data, including, for example, the time period and/or reporting structure from which it is derived. For example, as shown in FIG. 8, the selected financial data upon which scenarios are to be constructed has been undertaken is from twelve months of fiscal year 2014. The selected financial data may be displayed in reference data area 830. In some embodiments, a foreign currency share analysis of the selected financial data may be performed, and the foreign currency share of the foreign currencies present in the selected financial data may be displayed.

In scenario construction area 820, the user may construct various currency risk scenarios to simulate according to user-defined rules. The user may create a scenario by selecting the “Add Scenario” button. In some embodiments, the user may re-name the created scenario to a name of their choosing, for example a descriptive title such as “Optimistic.” The user may then add a rule to the scenario by selecting the “Add Rule” button. A rule for a scenario may comprise a rule type, a related currency or currencies, an action, and a value. A rule type may comprise the various changes discussed above, for example a business changes (i.e., overall revenue or cost change), foreign currency share changes, and/or foreign currency exchange rate changes. The related currency or currencies of a rule are those currency or currencies to which the rule applies. It is to be understood that certain rule types may be related to one, some, or none of the currencies. For example, a business change is applied to the financial data at a general level, and does not apply to a particular currency. Similarly, a foreign currency share may relate to a single currency, where a particular currency share changes by some amount, or may relate to two currencies, where the first currency is replaced by a second currency. In some embodiments, the available currency or currencies to be selected as a related currency are limited to those that are present in the selected financial data according to a foreign currency share analysis on the selected financial data.

The rule action defines the action to take on the selected currency or currencies according to the rule type. In some embodiments, the rule action may be one of increasing, decreasing, or replacement. Lastly, a rule value defines the amount by which the rule action is to be applied. For example, as shown in FIG. 8, rule 1 of the “Optimistic” scenario has a rule type of “Share of Currency,” a related currency of “EUR,” and action of increasing, and a value of 11%. A user may define multiple rules for a particular scenario to generate complex currency risk scenarios to simulate and analyze. A user may also define multiple scenarios, to analyze the currency risks associated with different predictions or courses of action. In some embodiments, the created scenarios and corresponding rules are stored for later retrieval.

After conducting the foreign currency band width analysis and selecting a foreign currency for further currency risk analysis, the user may select the “OK” button to generate and output the simulated data according to the selected scenario. In some embodiments, the output of the simulated data may be in an interface as described in relation to FIG. 7, above. The user may also select the “Cancel” button to return to the user to the currency risk simulator central menu 200.

In some embodiments, the scenario constructor and corresponding scenarios and rules may be implemented as a Standard Planning Function within the SAP® Business Rule Framework. The Business Rule Framework is an event-controlled runtime environment in which the system events are processed according to user-defined rules. In particular, the scenario constructor may be implemented as a framework that stores the above-described scenario constructor rules as processing steps within the SAP® Business Rule Framework in a user-defined sequence. The Standard Planning Function may then call the rules stored within the SAP® Business Rule Framework and execute them individually or in combination with other rules on the selected financial data in order to generate and display the simulated data. In other embodiments, when implemented as a Standard Planning Function within the SAP® Business Rule Framework, other Standard Planning Functions available within the SAP® Business Rule Framework may be used in the currency risk simulator of the present disclosure.

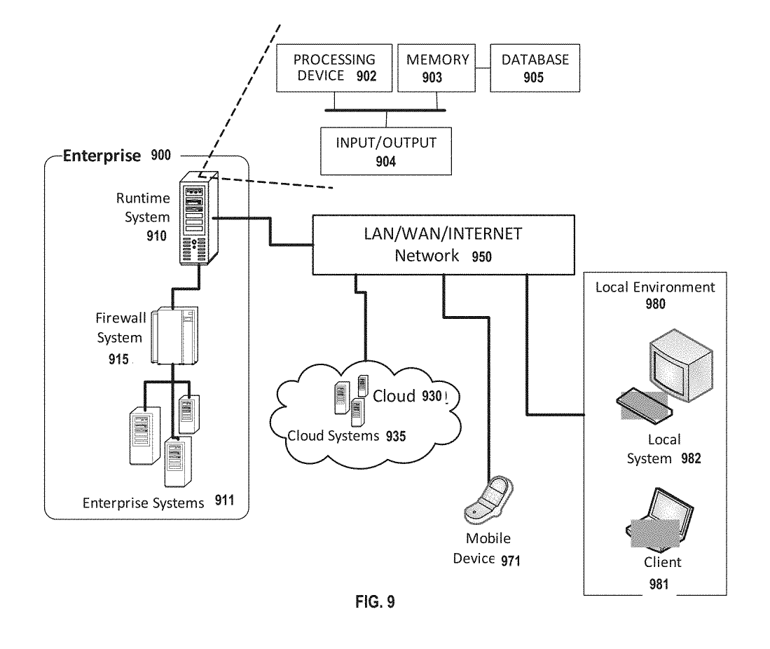

FIG. 9 shows an exemplary architecture of systems according to an example embodiment. Runtime system 910, may be connected to firewall system 915 and network 950. Network 950 may include a LAN, WAN, VPN, or the Internet. Mobile device 971, the local systems 982 and clients 981 in local environment 980, and the cloud systems 935 in the cloud environment 930 may also be connected to the network 950. The firewall system 915 may also be connected to the enterprise systems 911 and may provide an additional layer of security for enterprise systems 911 by preventing unauthorized access to these systems 911.

Each of the systems, clients, and devices in FIG. 9 may comprise any combination of one or more of inter alia a desktop computer, a notebook computer, a laptop computer, a tablet, a smartphone, a smartwatch, etc.

Each of the systems, clients, and devices in FIG. 9 may contain a processing device 902, memory 903 containing a database 905, and an input/output interface 904, all of which may be interconnected via a system bus. In various embodiments, database 905 may be an in-memory database. In-memory databases may deliver increased data access speed compared to relational databases stored outside of main memory, and consequently may provide faster program execution. Real-time program execution may also be implemented due to the increased speed of program execution. In various embodiments, each of the systems 911, 971, 910, 915, 930, 981, and 982 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 903 may contain different components for retrieving, presenting, changing, and saving data. Memory 903 may include a variety of memory devices, for example, Dynamic Random Access Memory (DRAM), Static RAM (SRAM), flash memory, cache memory, and other memory devices. Additionally, for example, memory 903 and processing device(s) 902 may be distributed across several different computers that collectively comprise a system.

Processing device 902 may perform computation and control functions of a system and comprises a suitable central processing unit (CPU). Processing device 902 may comprise a single integrated circuit, such as a microprocessing device, or may comprise any suitable number of integrated circuit devices and/or circuit boards working in cooperation to accomplish the functions of a processing device. Processing device 902 may execute computer programs, such as object-oriented computer programs, within memory 903.

Further, operation of the disclosed embodiments has been described in the context of servers and terminals that implement storage apparatus such as databases. These systems can be embodied in electronic devices or integrated circuits, such as application specific integrated circuits, field programmable gate arrays and/or digital signal processors. Alternatively, they can be embodied in computer programs that execute on personal computers, notebook computers, tablets, smartphones or computer servers. Such computer programs typically are stored in physical storage media such as electronic-, magnetic- and/or optically-based storage devices, where they may be read to a processor, under control of an operating system and executed. And, of course, these components may be provided as hybrid systems that distribute functionality across dedicated hardware components and programmed general-purpose processors, as desired.

The foregoing description has been presented for purposes of illustration and description. It is not exhaustive and does not limit embodiments of the disclosure to the precise forms disclosed. Modifications and variations are possible in light of the above teachings or may be acquired from the practicing embodiments consistent with the disclosure. For example, some of the described embodiments may include software and hardware, but some systems and methods consistent with the present disclosure may be implemented in software or hardware alone. Additionally, although aspects of the present disclosure are described as being stored in memory, this may include other computer readable media, such as secondary storage devices, for example, hard disks, floppy disks, or CD ROM; the Internet or other propagation medium; or other forms of RAM or ROM.

The disclosure is also directed to computer program products comprising software stored on any computer useable medium. In various embodiments, the computer readable medium is non-transitory. Such software, when executed in one or more data processing devices, causes data processing device(s) to operate as described herein. Embodiments of the disclosure employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

Based on the teachings contained in this disclosure, it will be apparent to persons skilled in the relevant art(s) how to make and use the disclosure using data processing devices, computer systems, and/or computer architectures other than that shown in FIG. 9. In particular, embodiments may operate with software, hardware, and/or operating system implementations other than those described herein.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

In addition, in the foregoing Detailed Description, various features may be grouped or described together for the purpose of streamlining the disclosure. This disclosure is not to be interpreted as reflecting an intention that all such features are required to provide an operable embodiment.

1. A method for simulating currency risk, the method comprising:
obtaining, from an in-memory database, reference financial data;
analyzing the reference data to obtain a currency mix comprising a base currency and at least one foreign currency, wherein the analysis determines the percentage share of the base currency and the at least one foreign currency;
generating simulated data by adjusting the reference data according to at least one user-defined adjustment; and
outputting, to a display device, the simulated data.

2. The method of claim 1, wherein the at least one user-defined adjustment includes a business change, where in at least one of revenues and costs are increased or decreased.

3. The method of claim 1, wherein the at least one user-defined adjustment includes a foreign currency share change, wherein the percentage share of at least one foreign currency is one of increased or decreased.

4. The method of claim 1, wherein the at least one user-defined adjustment includes a foreign currency exchange rate change, wherein the exchange rate between the base currency and the at least one foreign currency is one of increased or decreased.

5. The method of claim 1, wherein the reference financial data is at least one of an income statement, a balance sheet, and a cash flow.

6. The method of claim 1, wherein the generation of simulated data and output of simulated data occurs synchronously.

7. A non-transitory computer readable storage medium storing one or more programs configured to be executed by a processor, the one or more programs comprising instructions for:
obtaining, from an in-memory database, reference financial data;
analyzing the reference data to obtain a currency mix comprising a base currency and at least one foreign currency, wherein the analysis determines the percentage share of the base currency and the at least one foreign currency;
generating simulated data by adjusting the reference data according to at least one user-defined adjustment; and
outputting, to a display device, the simulated data.

8. The non-transitory computer readable storage medium of claim 7, wherein the at least one user-defined adjustment includes a business change, where in at least one of revenues and costs are increased or decreased.

9. The non-transitory computer readable storage medium of claim 7, wherein the at least one user-defined adjustment includes a foreign currency share change, wherein the percentage share of at least one foreign currency is one of increased or decreased.

10. The non-transitory computer readable storage medium of claim 7, wherein the at least one user-defined adjustment includes a foreign currency exchange rate change, wherein the exchange rate between the base currency and the at least one foreign currency is one of increased or decreased.

11. The non-transitory computer readable storage medium of claim 7, wherein the reference financial data is at least one of an income statement, a balance sheet, and a cash flow.

12. The non-transitory computer readable storage medium of claim 7, wherein the generation of simulated data and output of simulated data occurs synchronously.

13. A system to simulate currency risk, the system comprising:
a display; and
a processor configured to:
obtain, from an in-memory database, reference financial data;
analyze the reference data to obtain a currency mix comprising a base currency and at least one foreign currency, wherein the analysis determines the percentage share of the base currency and the at least one foreign currency;
generate simulated data by adjusting the reference data according to at least one user-defined adjustment; and
output, to the display device, the simulated data.

14. The system of claim 13, wherein the at least one user-defined adjustment includes a business change, where in at least one of revenues and costs are increased or decreased.

15. The system of claim 13, wherein the at least one user-defined adjustment includes a foreign currency share change, wherein the percentage share of at least one foreign currency is one of increased or decreased.

16. The system of claim 13, wherein the at least one user-defined adjustment includes a foreign currency exchange rate change, wherein the exchange rate between the base currency and the at least one foreign currency is one of increased or decreased.

17. The system of claim 13, wherein the reference financial data is at least one of an income statement, a balance sheet, and a cash flow.

18. The system of claim 13, wherein the generation of simulated data and output of simulated data occurs synchronously.
